(19) United States
(12) Patent Application Publication
(10) Pub. No.: US 2015/0181420 A1
(43) Pub. Date: Jun. 25, 2015

(54) METHOD AND APPARATUS FOR MONITORING A PREDEFINED OPERATION IN A MOBILE TERMINAL

(71) Applicant: Tencent Technology (Shenzhen) Company Limited, Shenzhen City (CN)

(72) Inventors: Jingwei Han, Shenzhen City (CN); Lichun Zhang, Shenzhen City (CN)

(21) Appl. No.: 14/408,829

(22) PCT Filed: Jun. 18, 2013
(86) PCT No.: PCT/CN2013/077377

§ 371 Date: Dec. 17, 2014

(30) Foreign Application Priority Data
Jun. 18, 2012 (CN) 20121021442.3

(51) Int. Cl. H04W 12/02; H04M 1/725

(52) U.S. Cl. CPC H04W 12/02; H04M 1/72563

(57) ABSTRACT

In a method for monitoring a preconfigured operation in a mobile terminal, one or more operations to be monitored and a trigger condition corresponding to each operation to be monitored are configured in the mobile terminal in advance, and an event processing module corresponding to each preconfigured operation is configured in the mobile terminal. The method includes: scanning a system log in the mobile terminal in real time; determining an operation currently being performed by an application running in a system according to an event recorded in the system log, determining whether the operation currently being performed by the application running in the system meets the preconfigured trigger condition; if meets, notifying the corresponding event processing module to perform subsequent processing.

### FIELD OF THE DISCLOSURE

The present disclosure relates to computer techniques, and more particularly, to a method and an apparatus for monitoring a predefined operation in a mobile terminal.

### BACKGROUND OF THE DISCLOSURE

With the development of technologies, mobile terminals such as cell phones become more and more popular and have more and more functions. In order to realize various functions of services, a plurality of application programs are usually installed in the mobile terminal. However, some applications may perform operations related to user data security without informing the user or getting authorization from the user, e.g., read contact list stored in the mobile terminal, open images stored in the mobile terminal, call a call record in the mobile terminal, etc., which threatens security of user data or user's privacy.

Therefore, in order to increase security level of the mobile terminal, it is required to effectively monitor operations of the application programs running in the mobile terminal.

### SUMMARY OF THE DISCLOSURE

Examples of the present disclosure provide a method and an apparatus for monitoring a predefined operation in a mobile terminal, so as to monitor all preconfigured operations simultaneously in one monitoring process and facilitate the monitoring of the preconfigured operations.

The technical solution of the present disclosure is as follows.

According to an example, a method for monitoring a preconfigured operation in a mobile terminal is provided. One or more operations to be monitored and a trigger condition corresponding to each operation are configured in the mobile terminal in advance. Each preconfigured operation corresponds to a corresponding event processing module. The method includes:
scanning a system log in the mobile terminal in real time;
determining an operation currently being performed by an application running in a system according to an event recorded in the system log, determining whether the operation currently being performed by the application running in the system meets the preconfigured trigger condition; if meets, notifying the corresponding event processing module to perform subsequent processing.

According to another example of the present disclosure, an apparatus for monitoring a preconfigured operation in a mobile terminal is provided. The apparatus includes: a configuring module, a monitoring module and at least one event processing module; wherein
the configuring module is to configure one or more operations to be monitored and a trigger condition corresponding to each operation to be monitored in the mobile terminal in advance, and send the preconfigured one or more operations and the trigger condition corresponding to each operation to the monitoring module;
the monitoring module is to scan a system log of the mobile terminal in real time, determine an operation currently being performed by an application running in a system according to an event recorded in the system log, determine whether the operation currently being performed by the application running in the system meets the trigger condition, and send a notification message to the event processing module if the operation being performed meets the preconfigured trigger condition; and
the event processing module is to perform a subsequent processing according to the notification message

In view of the above, in the technical solution of the present disclosure, one or more operations to be monitored and a trigger condition corresponding to each operation are configured. An event processing module corresponding to each operation is also configured. Then the system log is scanned in real time. according to the event recorded in the system log, an operation currently being performed by an application running in the system is determined. It is determined whether the operation currently being performed by the application running in the system meets the trigger condition. If yes, a notification message is sent to the event processing module. Thus, the event processing module may perform subsequent processing according to the notification message. As such, all preconfigured operations may be monitored in one monitoring process. It is not required to configure a separate monitoring process for each preconfigured operation, which makes the monitoring of each preconfigured operation simple and convenient.

### BRIEF DESCRIPTION OF THE DRAWINGS

FIG. 1 shows a flowchart of a method for monitoring a particular operation in a mobile terminal according to a conventional system.

FIG. 2 shows an example of a method for monitoring a preconfigured operation in a mobile terminal according to the present disclosure.

FIG. 3 shows an example of an apparatus for monitoring a preconfigured operation in a mobile terminal according to the present disclosure.

### DETAILED DESCRIPTION OF THE DISCLOSURE

The present disclosure is described in further detail hereinafter with reference to accompanying drawings and examples to make the technical solution and merits therein clearer.

In order to increase security level of a mobile terminal, it is required to effectively monitor various operation behaviors of applications running in the mobile terminal. In a conventional system, a particular operation behavior is monitored separately to increase the security level of the mobile terminal. For example, an operation of reading a contact list is monitored separately, an operation of opening images is monitored separately, or an operation of calling a call record is monitored separately, etc.

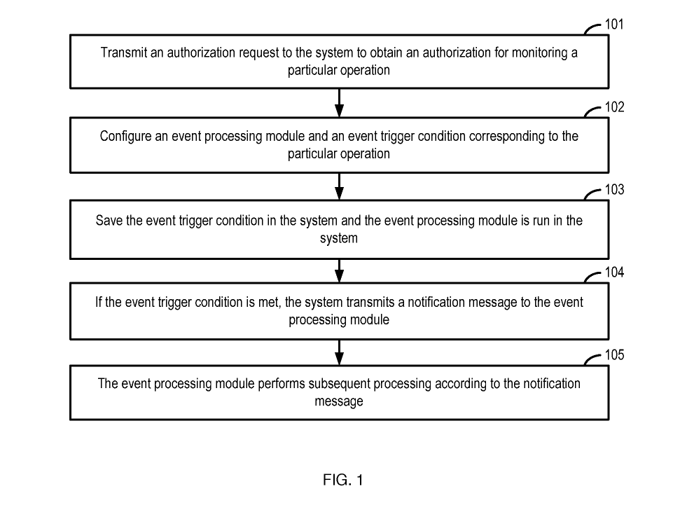

FIG. 1 shows a flowchart of a method for monitoring a particular operation in a mobile terminal according to a conventional system. As shown in FIG. 1, when a particular operation is to be monitored, the following blocks may be performed.

At block 101, an authorization request is transmitted to the system to obtain an authorization for monitoring a particular operation.

In a conventional mobile terminal, before the particular operation is monitored, an authorization for monitoring the operation has to be obtained from the system. Therefore, in this block, an authorization request is transmitted to the system. After the system confirms that the monitoring can be performed, the authorization for monitoring the particular operation is obtained. The above block 101 may also be referred to as a process of declaring capability on monitoring a particular operation to the system.

At block 102, an event processing module and an event trigger condition corresponding to the particular operation are configured.

At block 103, the event trigger condition is saved in the system and the event processing module is run in the system.

At block 104, if the event trigger condition is met, the system transmits a notification message to the event processing module.

At block 105, the event processing module performs subsequent processing according to the notification message.

In this block, the subsequent processing may include: send alarm information to the user, record information of the application performing the particular operation, and/or interrupt the application performing the particular operation, etc.

Through the above blocks 101˜105, the particular operation may be monitored in the conventional system.

In view of the above blocks 101˜105, the above monitoring method merely monitors one particular operation. If there are a plurality of operations to be monitored, a monitoring process consistent with or similar as the above blocks 101˜105 has to be performed with respect to each operation to be monitored.

Thus, the conventional method for monitoring operation merely monitors a particular operation independently. The monitoring process of each operation is independent to each other and cannot be multiplexed. Therefore, it is impossible to monitor all preconfigured operations in one monitoring process simultaneously. In addition, for each particular operation to be monitored, the conventional monitoring method has to obtain an authorization for monitoring the particular operation before performing the monitoring operation. The procedure is complex and inconvenient.

Therefore, an example of the present disclosure provides a method and an apparatus for monitoring a preconfigured operation in a mobile terminal, so as to monitor all preconfigured operations in one monitoring process simultaneously. As such, the monitoring of each preconfigured operation becomes simple and convenient.

At present, mobile terminals usually have system logs for recording various operations executed during system running procedure. The system log is updated in real time. Therefore, there is a record in the system log of the mobile terminal for each operation performed by each application.

In various examples of the present disclosure, the system log is scanned in real time. According to the event recorded in the system log, operations currently being performed by various applications running in the system may be obtained.

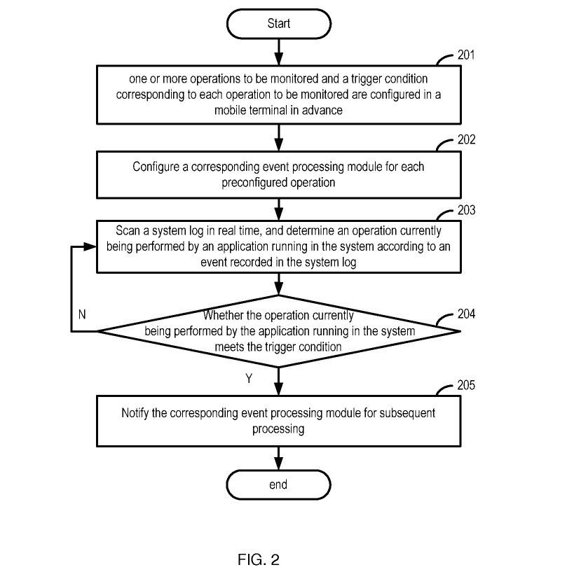

FIG. 2 shows an example of a method for monitoring a preconfigured operation in a mobile terminal according to the present disclosure. As shown in FIG. 2, the method for monitoring the preconfigured operation in the mobile terminal includes the following.

At block 201, one or more operations to be monitored and a trigger condition corresponding to each operation to be monitored are configured in a mobile terminal in advance.

In the example of the present disclosure, the preconfigured operation to be monitored may include any one or any combination of: reading a contact list in the mobile terminal, opening images in the mobile terminal, calling a call record in the mobile terminal, or any other operations to be monitored.

In addition, the example of the present disclosure, the trigger condition may be configured in advance according to a practical requirement. For example, the trigger condition may be configured as: at least one application currently running in the mobile terminal is performing at least one preconfigured operation.

For example, if the preconfigured operations are reading the contact list in the mobile terminal and opening the images in the mobile terminal, the trigger condition may be as follows:
at least one application currently running in the mobile terminal is performing the operation of reading the contact list in the mobile terminal and/or opening the images in the mobile terminal.

At block 202, an event processing module is configured for each preconfigured operation.

In this block, an event processing module is configured for each preconfigured operation. Therefore, each preconfigured operation has an event processing module uniquely corresponds to it for performing the subsequent processing. The subsequent processing may include: record information of the application performing the preconfigured operation, interrupt the application performing the preconfigured operation, and/or send alarm information or inquiry information to the user and process according to an instruction of the user or a default configuration of the user (e.g., allow or forbid the running of the application), or any other operations configured in advance.

For example, if the preconfigured operation includes reading the contact list in the mobile terminal, a contact list reading event processing module may be configured for this operation, so as to send alarm information or inquiry information to the user to notify the user that a particular application in the mobile terminal is reading the contact list, and may further process according to user's instruction or a default operation configured by the user (e.g., allow or forbid the running of the application).

The above blocks 201 and 202 are performed once when the configuration is performed for the first time. After the configuration is completed, if the operations to be monitored, the trigger conditions and the event processing modules have no change, it is not required to perform blocks 201 and 202 again.

At block 203, a system log of the mobile terminal is scanned in real time, and an operation currently being performed by an application running in the mobile terminal is determined according to an event recorded in the system log.

At present, mobile terminals usually have system logs to record various operations executed during system running procedure. The system log is updated in real time. Therefore, there is a record in the system log of the mobile terminal for each operation performed by the application.

In this block, the system log is scanned in real time. According to the event recorded in the system log, operations currently being performed by various applications running in the system may be obtained.

At block 204, it is determined whether the operation being performed by the application running in the system meets the trigger condition. If yes, block 205 is performed to inform a corresponding event processing module to perform subsequent processing; otherwise, the method returns to block 203.

In this block, it is firstly determined whether the operation being performed by the application running in the system meets the preconfigured trigger condition according to the event recorded in the system log. For example, it is determined according to the event recorded in the system log whether at least one application running in the system has performed at least one preconfigured operation. If yes, the system sends a notification message to the event processing module corresponding to the operation currently being performed to inform the corresponding event processing module to perform the subsequent processing. In the example of the present disclosure, the notification message may carry information of the operation currently being performed and/or information of the application currently performing the operation.

The event processing module corresponding to the operation currently being performed may perform corresponding subsequent processing according to the notification message, e.g., record information of the application performing the operation, interrupt the application performing the operation, and/or send alarm information or inquiry information to the user and operate according to an instruction of the user or according to a preconfigured default operation (e.g., allow or forbid the running of the application), or any other preconfigured processing.

In view of the above blocks 203˜204, all preconfigured operations may be monitored simultaneously in one monitoring process through scanning the system log. It is not required to perform a separate monitoring process for each preconfigured operation. Thus, the monitoring becomes simple and convenient. In addition, since the above monitoring method merely monitors the system log without monitoring each operation separately, it is not required to obtain authorization of the system for monitoring the operation, which effectively reduces load of the system and simplifies the monitoring procedure.

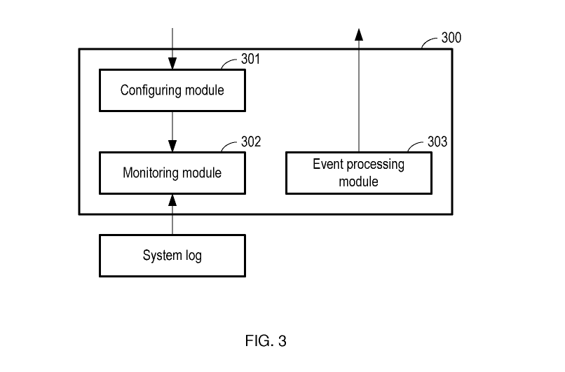

In accordance with the above method provided by the example of the present disclosure, another example of the present disclosure provides an apparatus for monitoring a preconfigured operation in a mobile terminal, as shown in FIG. 3.

FIG. 3 shows an example of an apparatus for monitoring a preconfigured operation in a mobile terminal according to the present disclosure.

As shown in FIG. 3, the apparatus 300 for monitoring the preconfigured operation in the mobile terminal provided by the example of the present disclosure includes: a configuring module 301, a monitoring module 302 and at least one event processing module 303.

The configuring module 301 is to configure one or more operations to be monitored and a trigger condition corresponding to each preconfigured operation in the mobile terminal, and send the preconfigured one or more operations and the trigger condition corresponding to each operation to the monitoring module 302.

The monitoring module 302 is to scan a system log of the mobile terminal in real time, determine an operation currently being performed by an application running in the system according to an event recorded in the system log, determine whether the operation currently being performed by the application running in the system meets the trigger condition, and send a notification message to the event processing module 303 if the operation being performed meets the preconfigured trigger condition.

The event processing module 303 is to perform a subsequent processing according to the notification message. For example, it records information of the application performing the preconfigured operation, interrupt the application performing the preconfigured operation, and/or send alarm information or inquiry information to the user and process according to the user's instruction or a default configuration of the user (e.g., allow or forbid running of the application), or any other preconfigured operation.

The present disclosure further provides a machine readable storage medium, includes a set of instructions executable by one or more processors to perform the method for monitoring a preconfigured operation in a mobile terminal as described above. In particular, a system or an apparatus configured with the machine readable storage medium is provided. The storage medium includes program codes for implementing functions described in the above examples, and a computer (or CPU or MCU) of the system or the apparatus reads and executes the program codes in the storage medium.

At this time, the program codes read from the storage medium may implement the functions of any example of present disclosure. Therefore, the program codes and the storage medium storing the program codes are parts of the present disclosure.

The storage medium storing the program codes may be a floppy disk, a hard disk, a magnetic disk, a compact disk (e.g., CD-ROM, CD-R, CD-RW, DVD-ROM, DVD-RAM, DVD-RW, DVD+RW), magnetic tape, non-transitory storage card and ROM. In one example, the program codes may be downloaded from a server computer via a communication network.

In addition, it should be noted that part of all of the operations may also be implemented by an operating system of a computer based on the program codes, so as to realize the functions of any example of the present disclosure.

In addition, the program codes read from the storage medium may be written in a memory in an extended board inserted in the computer or written in a memory in an extended unit connected with the computer. Instructions based on the program codes are executed by the CPU on the extended board or extended unit to implement part or all functions to realize the functions of any example of the present disclosure.

In view of the above, in the technical solution of the present disclosure, one or more operations to be monitored and a trigger condition corresponding to each operation are configured. An event processing module corresponding to each operation is also configured. Then the system log is scanned in real time. according to the event recorded in the system log, an operation currently being performed by an application running in the system is determined. It is determined whether the operation currently being performed by the application running in the system meets the trigger condition. If yes, a notification message is sent to the event processing module. Thus, the event processing module may perform subsequent processing according to the notification message. As such, all preconfigured operations may be monitored in one monitoring process. It is not required to configure a separate monitoring process for each preconfigured operation, which makes the monitoring of each preconfigured operation simple and convenient. In addition, since the above monitoring method merely monitors the system log without monitoring each operation separately, it is not required to obtain authorization of the system for monitoring the operation, which effectively reduces load of the system and simplifies the monitoring procedure.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

1. A method for monitoring a preconfigured operation in a mobile terminal, wherein one or more operations to be monitored and a trigger condition corresponding to each operation to be monitored are configured in the mobile terminal in advance, and an event processing module corresponding to each preconfigured operation is configured in the mobile terminal, the method comprises:
scanning a system log in the mobile terminal in real time;
determining an operation currently being performed by an application running in a system according to an event recorded in the system log, determining whether the operation currently being performed by the application running in the system meets the preconfigured trigger condition; if meets, notifying the corresponding event processing module to perform subsequent processing.

2. The method of claim 1, wherein the preconfigured operation to be monitored comprises any one or any combination of:
reading a contact list of the mobile terminal, opening images in the mobile terminal, and calling a call record in the mobile terminal.

3. The method of claim 1, wherein the trigger condition comprises:
at least one application running in the system is performing at least one of the preconfigured operation.

4. The method of claim 1, wherein the notifying the corresponding event processing module to perform subsequent processing comprises:
sending a notification message to the event processing module corresponding to the operation currently being performed; and
performing, by the event processing module, the subsequent processing according to the notification message.

5. The method of claim 4, wherein the notification message carries information of the operation currently being performed and/or information of the application performing the preconfigured operation.

6. The method of claim 1, wherein the subsequent processing comprises:
recording information of the application performing the preconfigured operation, interrupting the application performing the preconfigured operation, and/or sending alarm information or inquiry information to a user and operating according to an instruction of the of the user or a default operation configured in advance.

7. An apparatus for monitoring a preconfigured operation in a mobile terminal, comprising: a configuring module, a monitoring module and at least one event processing module; wherein
the configuring module is to configure one or more operations to be monitored and a trigger condition corresponding to each operation to be monitored in the mobile terminal in advance, and send the preconfigured one or more operations and the trigger condition corresponding to each operation to the monitoring module;
the monitoring module is to scan a system log of the mobile terminal in real time, determine an operation currently being performed by an application running in a system according to an event recorded in the system log, determine whether the operation currently being performed by the application running in the system meets the trigger condition, and send a notification message to the event processing module if the operation being performed meets the preconfigured trigger condition; and
the event processing module is to perform a subsequent processing according to the notification message.

8. The apparatus of claim 7, wherein the preconfigured operation to be monitored comprises any one or any combination of:
reading a contact list of the mobile terminal, opening images in the mobile terminal, and calling a call record in the mobile terminal.

9. The apparatus of claim 7, wherein the trigger condition comprises:
at least one application running in the system is performing at least one of the preconfigured operation.

10. The apparatus of claim 7, wherein the notification message carries information of the operation currently being performed and/or information of the application performing the preconfigured operation.

11. The apparatus of claim 7, wherein the event processing module is further to:
record information of the application performing the preconfigured operation, interrupt the application performing the preconfigured operation, and/or send alarm information or inquiry information to a user and operate according to an instruction of the of the user or a default operation configured in advance.
